(19) United States
(12) Patent Application Publication
(10) Pub. No.: US 2026/0002275 A1
(43) Pub. Date: Jan. 1, 2026

(54) POWDER-FILLED ELECTRODE AND DEVICE INCLUDING SAME

(71) Applicant: SK INNOVATION CO., LTD., Seoul (KR)

(72) Inventors: Chung Seop LEE, Daejeon (KR); Tae Wan KIM, Daejeon (KR); Yoon Hyuk JANG, Daejeon (KR); Tae Hwa JEON, Daejeon (KR)

(21) Appl. No.: 19/243,709

(22) Filed: Jun. 20, 2025

(30) Foreign Application Priority Data
Jun. 27, 2024 (KR) 10-2024-0084648

(51) Int. Cl. C25B 13/02; C02F 1/46; C02F 101/34; C25B 11/037; C25B 11/052; C25B 11/061; C25B 11/083; C25B 13/08; G01N 27/30

(52) U.S. Cl. CPC C25B 13/02; C02F 1/46; C25B 11/037; C25B 11/052; C25B 11/061; C25B 11/083; C25B 13/08; G01N 27/308; C02F 2101/345

(57) ABSTRACT

Proposed is an electrode, which includes a first frame and a second frame, wherein the first and second frames are non-conductors, and at least one of the first and second frames includes a plurality of cavities, a packing member disposed between the first and second frames and attached to one of the first and second frames, wherein the first frame, the second frame, and the packing member define an inner space that is open in one direction, a current-collecting member interposed in the inner space, and a powdered electrode active material with which the plurality of cavities is filled, the electrode active material contacting the current-collecting member. The electrode is usable for various purposes by changing the electrode active material alone, and the current-collecting member and the frames are reusable, which is economically advantageous.

### CROSS REFERENCE TO RELATED APPLICATION

The present application claims priority to Korean Patent Application No. 10-2024-0084648, filed Jun. 27, 2024, the entire contents of which are incorporated herein for all purposes by this reference.

### BACKGROUND

### 1. Technical Field

The embodiments of the present disclosure relate generally to an improved electrode and a device including the same.

### 2. Description of the Related Art

Various water treatment technologies are used in the wastewater treatment field where hazardous substances or contaminants are removed from industrial wastewater discharged from factories or workplaces. However, the properties of wastewater are more diversified and complicated with industrial development, so treatment through existing biological or physicochemical processes becomes more challenging. Recently, attempts have been made to use electrochemical treatment methods to remove such non-degradable substances. Electrochemical water treatment can decompose various organic contaminants, does not require the use of toxic chemicals, and is a water treatment technology that is gaining attention in terms of treatment efficiency and environmental friendliness. This electrochemical water treatment is a technology involving adding electrolytes or other additives to tap water wastewater, sewage, or contaminated water and then applying electricity to a cathode and an anode installed in a reactor to attach contaminants to the electrodes for oxidation through direct electron transfer or to decompose contaminants by producing an oxidizer through an electrochemical reaction.

In the meantime, active research is being conducted on various types of electrodes and materials to improve electrochemical water treatment efficiency and reduce costs.

### SUMMARY

The embodiments of the present disclosure relate generally to an electrode and a device including the same for use in electrochemical treatment of water. The electrode may be a powder-filled electrode.

According to an embodiment of the present disclosure, an electrode is provided which is manufactured by a simplified process and is applicable to diversified fields. In particular, the electrode, according to an embodiment of the present disclosure, may be widely applied in the green technology field, such as in an electrochemical process for water treatment.

According to an embodiment of the present disclosure an electrode may include a first frame and a second frame, wherein the first and second frames are non-conductors, and at least one of the first and second frames includes a plurality of cavities; a packing member disposed between the first and second frames and attached to one of the first and second frames, wherein the first frame, the second frame, and the packing member define an inner space that is open in one direction; a current-collecting member interposed in the inner space; and a powdered electrode active material with which the plurality of cavities is filled, the electrode active material contacting the current-collecting member.

According to an embodiment, the first and second frames may include polycarbonate (PC), polytetrafluoroethylene (PTFE), or polyether ether ketone (PEEK).

According to an embodiment, each of the plurality of cavities may have a diameter in the range of 2 mm to 20 mm.

According to an embodiment, the plurality of cavities may have a total cross-sectional area accounting for 3% to 60% of the total area of the electrode.

According to an embodiment, each of the first and second frames may have a thickness in the range of 1 mm to 3 mm.

According to an embodiment, the packing member may include silicone, a synthetic rubber, a synthetic resin, or a combination thereof.

According to an embodiment, the current-collecting member may include Pt, Au, Cu, Ni, Ti, or a combination thereof.

According to an embodiment, the current-collecting member includes a conductive substrate and a current collector layer with which an upper portion of the conductive substrate is coated, wherein the current collector layer may be wire-type.

According to an embodiment, the electrode active material may include boron-doped diamond (BDD), magneli, zerovalent iron (ZVI), aluminum (Al), Pt, IrO₂, RuO₂, or a combination thereof.

“Magneli” also known as “Magneli-phase oxides” refer to a class of titanium sub-oxides (Ti₄O₇, Ti₅O₉, Ti₆O₁₁, etc.), characterized by crystallographic shear planes, providing enhanced electrical conductivity and chemical stability.

According to an embodiment, the electrode active material may be filled in an amount accounting for 90 vol % to 100 vol % of the cavities.

According to an embodiment, the electrode further includes a conductive powder, wherein an inner space of the cavities may be filled with the conductive powder at a position deeper than that of the electrode active material.

According to another embodiment of the present disclosure, a device including the above-described electrode is provided, wherein the device is used for at least one of water treatment, water electrolysis, and sensing.

According to another embodiment of the present disclosure, an electrode may include: first and second non-conductor frames comprising a plurality of cavities filled at least partially with an electrode active material; a packing member disposed between the first and second frames; and a current-collecting member disposed in an inner space defined by the first frame, the second frame, and the packing member, wherein the electrode active material contacts the current-collecting member.

According to an embodiment of the present disclosure, the first and second frames comprise polycarbonate (PC), polytetrafluoroethylene (PTFE), or polyether ether ketone (PEEK). According to an embodiment of the present disclosure, each of the plurality of cavities has a diameter in a range of 2 mm to 20 mm.

According to an embodiment of the present disclosure, each of the plurality of cavities has a diameter in a range of 2 mm to 20 mm, wherein the plurality of cavities has a total cross-sectional area accounting for 3% to 60% of the total area of the electrode, and wherein each of the first and second frames has a thickness in a range of 1 mm to 3 mm.

According to an embodiment of the present disclosure, the packing member comprises silicone, a synthetic rubber, a synthetic resin, or a combination thereof.

According to an embodiment of the present disclosure, the current-collecting member comprises Pt, Au, Cu, Ni, Ti, or a combination thereof.

According to an embodiment of the present disclosure, the current-collecting member comprises: a conductive substrate; and a current collector layer with which an upper portion of the conductive substrate is coated, wherein the current collector layer is wire-type.

According to an embodiment of the present disclosure, the electrode active material comprises boron-doped diamond (BDD), magneli, zerovalent iron (ZVI), aluminum (Al), Pt, IrO₂, RuO₂, or a combination thereof, wherein an inner space of the cavities is filled with the conductive powder at a position deeper than that of the electrode active material, and wherein the electrode active material is filled in an amount accounting for about 90 percent of the cavities.

According to an embodiment of the present disclosure, the application fields of an electrode can be diversified, and components of the electrode, other than an electrode active material, can be reused.

### BRIEF DESCRIPTION OF THE DRAWINGS

FIGS. 1A and 1B are schematic diagrams illustrating electrode configurations according to an embodiment of the present disclosure;

FIG. 2 is an image of a first frame and a second frame of an electrode according to an embodiment of the present disclosure;

FIG. 3 is an image showing an inner space of an electrode, according to an embodiment of the present disclosure, and a current-collecting member interposed in the inner space;

FIG. 4 is a schematic diagram of a current-collecting member including a wire-type current collector layer.

FIG. 5 is a graph showing cyclic voltammetry results for an electrode according to an example;

FIG. 6 is a graph showing measurement results of phenol oxidation level for an electrode according to an example; and

FIG. 7 is an image showing visual observation of the result of producing an electrochemical coagulant using an electrode according to an example.

### DETAILED DESCRIPTION

Hereinafter, the embodiments of the present disclosure will be described in detail with reference to the accompanying drawings. However, these are only for illustrative purposes, and the embodiments may not be limited only to the specific embodiments illustrated below.

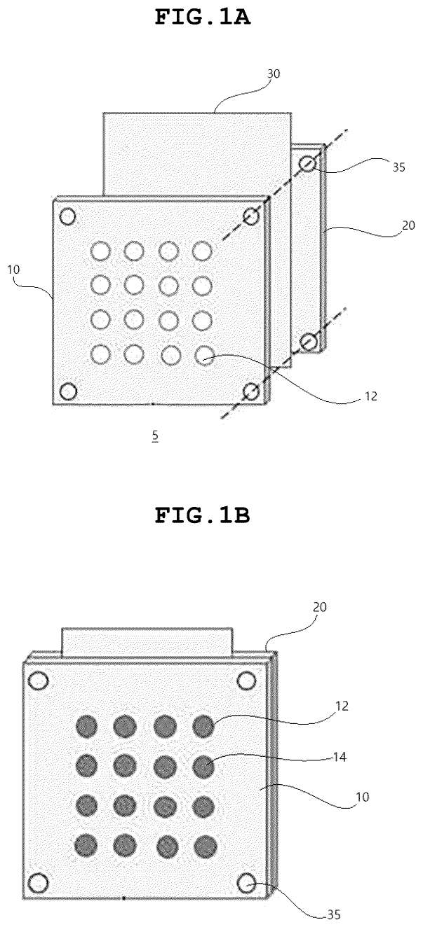

According to the embodiment of FIG. 1A, an electrode of the present disclosure is generally designated with numeral 5 and may include a first frame 10 and a second frame 10. The first and second frames 10, 20 may be non-conductors. At least one of the first and second frames 10, 20 may include a plurality of cavities 12. As illustrated in FIGS. 1A and 1B, the first and second frames 10, 20 may be the same in size and may be fixed to exactly overlay each other. To fix the two frames 10, 20 to be overlaid, a fixing member 35 such as bolts and nuts may be used. For example, the bolts and nuts may be made of PEEK. When using a current-collecting member 30 (also referred to as a current collector) to be interposed between the two frames, the first and second frames 10, 20 act to prevent direct contact between the current-collecting member 30 and at least one liquid such as an electrolyte. To protect such a current-collecting member 30, the first and second frames 10, 20 are corrosion-resistant and acid-resistant to an electrolyte. In addition, the first and second frames 10, 20 are required not to influence the electrical flow between the current collector 30 and an electrode active material and thus are non-conductors.

At least one of the first and second frames 10, 20 may include the plurality of cavities 12, and the cavities may be filled with an electrode active material 14, as will be described below. The cross-sectional shape of the cavities 12 is not limited and may, for example, be circular as illustrated in FIGS. 1A and 1B, or rectangular, or polygonal.

According to an embodiment, the first and second frames 20, 30 may include PC, PTFE, or PEEK. The above-listed materials are non-conductors and are suitable for use as the frame due to being corrosion-resistant to the electrolyte based on low chemical reactivity. Bolts and nuts used to secure the first and second frames may be made of PEEK, offering advantages in manufacturing efficiency and precise size control. The bigger the frame size, the greater the number of bolts and nuts required to fasten the first and second frames more firmly. For example, the number of bolts and nuts may be 4 or greater.

According to an embodiment, each of the plurality of cavities may have a diameter in the range of 2 mm to 20 mm. The plurality of cavities may be filled with the electrode active material and thus may serve as a reaction site of the electrode. Depending on the diameter (or cross-sectional size) of the cavities, the amount of the electrode active material with which the inside of the cavity is filled may vary, and the ratio of the area that the reaction site accounts for with respect to the unit area of the electrode may be determined. Hence, the amount of electrode active material filling the cavities may vary based on the diameter or cross-sectional size of the cavities, influencing the proportion of the reaction site within the electrode's unit area. When the plurality of cavities has a diameter of less than 2 mm, the ratio of the area that the reaction site accounts for with respect to the unit area of the electrode may be too low for a particular purpose. For example, when using the electrode for purposes such as water treatment and water electrolysis, the desired level of reactions, for example, electrochemical oxidation reactions, may fail to occur when the plurality of cavities has a diameter of less than 2 mm. When the plurality of cavities has a diameter greater than 20 mm, the degree to which the electrode reactivity increases is insignificant compared to the amount of the electrode active material with which the cavities are filled, so the efficiency of increasing the reactivity compared to the cost may become poor. For example, when the cavities in the electrode are too large (greater than 20 mm in diameter), adding more electrode active material doesn't significantly improve the battery's performance. That is, while more material is used to fill the cavities, the actual increase in reactivity is minimal, making it cost-inefficient.

Hence, it has been found rather unexpectedly that there is a balance between cavity size, reactivity, and electrode active material cost-beyond a certain size, the benefit of increased reactivity does not justify the extra material used. In addition, there is a risk that the current-collecting member is exposed to the electrolyte because the electrode active material with which the cavities are filled escapes the cavities. According to an embodiment, each of the plurality of cavities may have a diameter in the range of 5 mm to 18 mm, which may be more specifically in the range of 10 mm to 15 mm. Even when the cross-sectional shape of the cavities is square, the cavities may have each side with a length corresponding to the cross-sectional area of the circular cavities having the above-described diameter.

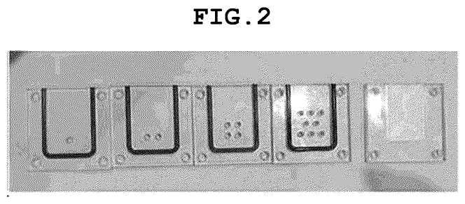

According to an embodiment, the plurality of cavities may have a total cross-sectional area accounting for 3% to 60% of the total area of the electrode. Referring to FIG. 2, frames with different numbers of cavities present per unit area are illustrated. While the plurality of cavities is filled with the electrode active material and thus serves as the reaction site of the electrode, as described above, the total cross-sectional area of the cavities relative to the total area of the electrode, which is determined by the number of cavities, along with the diameter of the cavities, is a factor that determines the electrode reactivity. That is, any user of the electrode may achieve the desired level of electrode reactivity by controlling not only the diameter of the cavities but also the number and also the cross-sectional area of the cavities relative to the total area of the electrode. When the total cross-sectional area of the plurality of cavities accounts for less than 3% of the total area of the electrode, the electrochemical oxidation reactivity of the electrode may not be high enough to be used for water treatment purposes. When the total cross-sectional area of the plurality of cavities accounts for more than 60% of the total area of the electrode, there is a problem in that the durability of the frame may become poor. According to an embodiment, the total cross-sectional area of the plurality of the cavities 12 may account specifically for 5% to 50%, or more specifically for 10% to 40% of the total area of the electrode.

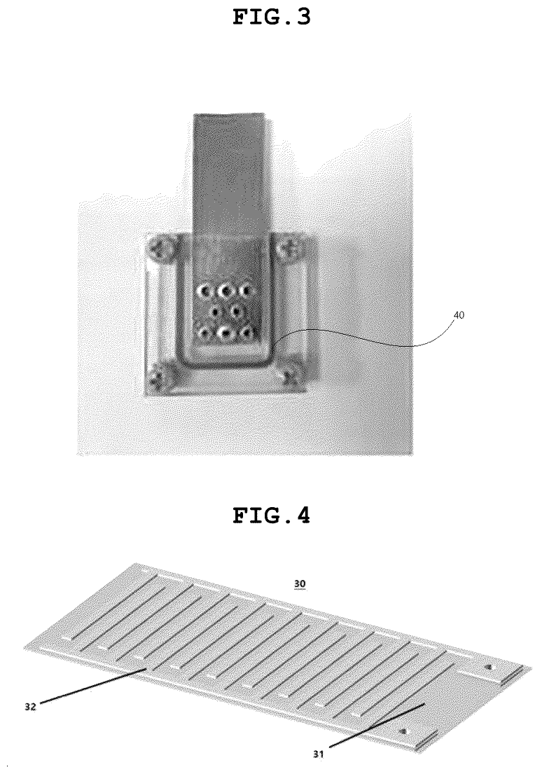

According to an embodiment, each of the first and second frames 10, 20 may have a thickness in the range of 1 mm to 3 mm. Each thickness of the first and second frames 10, 20, along with the diameter of the cavities 12, determines the volume of the cavities 12. The thicker the first and second frames 10, 20, the greater the volume of the cavities included in the first and second frames 10, 20, meaning that the amount of the electrode active material 14 with which a single cavity 12 may be filled increases. When each thickness of the first and second frames 10, 20 is less than 1 mm, damage to the frame may occur due to the pressure applied to compress the electrode active material 14 and fill the cavities 12 with the electrode active material 14. When each thickness of the first and second frames 10, 20 is greater than 3 mm, an excessive amount of unnecessary electrode active materials, of the electrode active material with which the cavities are filled, that are positioned inside the cavities and have failed to participate in the reaction may exist, resulting in reduced cost efficiency. According to an embodiment, each of the first and second frames may specifically have a thickness in the range of 1.2 mm to 2.5 mm, which may be more specifically in the range of 1.5 mm to 2.0 mm. The electrode may include a packing member 40 being positioned between the first and second frames 10, 20 and attached to one of the first and second frames. As shown in FIG. 3, the packing member 40 is positioned between the first and second frames and thus defines an inner space that is open in one direction between the first and second frames. When the electrode is immersed in liquids such as an electrolyte when in use, the packing member may form the inner space that is closed off in all but one direction unexposed to the electrolyte, thus preventing direct contact of the current-collecting member 30, to be interposed in the inner space, with the electrolyte and corrosion.

According to an embodiment, the packing member may include silicone, a synthetic rubber, a synthetic resin, or a combination thereof. The packing member may make physical contact with the current-collecting member 30 to be interposed in the inner space. Thus, when the packing member is conductive, the electrical properties of the electrode may be adversely affected, making control over the electrical properties of the electrode challenging. For this reason, the packing member is made preferably of a non-conductor. In addition, while the packing member makes direct contact with the electrolyte when the electrode is immersed in the electrolyte when in use, the packing member is preferably corrosion-resistant to the electrolyte for protecting the current-collecting member to be interposed in the inner space. The above-listed materials are non-conductors and are suitable for use as the packing member due to being corrosion-resistant to the electrolyte.

The electrode 5 includes the current-collecting member 30 interposed in the inner space between the first and second frames 10, 20. The current-collecting member 30 may be connected to a power source and may perform the function of transmitting current supplied from the power source to the electrode active material 14. As described above, when the electrode 5 is immersed in liquids such as an electrolyte when in use, the current-collecting member 30 is interposed in the inner space configured to prevent the material therein from making contact with the electrolyte and, therefore, does not make direct contact with the electrolyte. Among the components of the electrode, according to the embodiments of the present disclosure, the first frame 10, the second frame 20, and the packing member 30 are corrosion-resistant to the electrolyte, and the current-collecting member 30 does not make direct contact with the electrolyte. Thus, there is an advantage in that the electrode 5 is reusable without causing corrosion or damage even after being immersed in the electrolyte when in use.

According to an embodiment, the current-collecting member 30 may include Pt, Au, Cu, Ni, Ti, or a combination thereof. The material used as the current-collecting member 30 is electrically conductive and thus may transmit current supplied from the power source to the electrode active material 14. In addition, there are no limitations in this material as long as it tends to be less ionized than the electrode active material 14 and thus is not ionized or oxidized when making indirect contact with the electrolyte, for example, when being in contact with the electrode active material making direct contact with the electrolyte. From this perspective, the above-listed metals are suitable for use as the current-collecting member 30.

According to an embodiment, the current-collecting member 30 may include a conductive substrate 31 and a current collector layer 32 with which an upper portion of the conductive substrate is coated. The current collector layer may be wire-type. An example of a current-collecting member including a wire-type current collector layer is shown in FIG. 4. A wire-type current collector refers to metal wires that are arranged in a protruding form on the conductive substrate. The conductive substrate may perform a supporting role for the wire-type current collector layer and is made of an electrically conductive material. In addition, the conductive substrate has a thickness comparable to the thickness of the packing member in the stacking direction of the first and second frames so that contact between the electrode active material and a conductive layer is possible in the inner space of the electrode. The current collector layer, which is a layer that acts as a practical current collector, may be made of Pt, Au, Cu, Ni, or a combination thereof, along with the above-described metals usable as the current-collecting member. When used for water treatment devices and the like, the current collector layer may make contact with a power source (not shown) and the electrode active material 14, thus transmitting current supplied from the power source to the electrode active material 14. The current collector layer may be a wire-type, so that the contact area thereof with the electrode active material may be reduced compared to that of a plate-type (also known as planar) current collector layer. The reduced contact area between the current collector layer and the electrode active material may provide an advantage in that an oxygen evolution reaction (OER), a possible side reaction occurring at the contact surface thereof, may be prevented or occur at a minimum degree. Furthermore, when using expensive metals such as Pt as the current collector layer, such a metal is formed into a wire type, thus reducing manufacturing costs compared to when using a plate-type current collector layer.

The electrode 5 may include powdered electrode active material 14 with which the plurality of cavities 12 is filled. The electrode active material 14 may make direct contact with the electrolyte during a reaction by filling the plurality of cavities 12 and, at the same time, may prevent direct contact between the electrode 5 and the electrolyte through the cavities 12. The powdered electrode active material 14 may be in contact with the current collector layer and thus may act to cause an electrochemical reaction by receiving current from the current collector layer when the current is supplied to the electrode 5. The electrode 5 may include various electrode active materials depending on the purpose.

According to an embodiment, the electrode active material may include BDD, magneli, ZVI, Al, Pt, IrO₂, RuO₂, or a combination thereof. Such electrode active materials may be included selectively in the electrode depending on the purpose of the electrode. For example, when using the electrode for the purpose of removing the total organic carbon (TOC) in wastewater, the electrode active material may include BDD or magneli. In addition, when using the electrode as a consumable anode for electrochemical water treatment, the electrode active material may include Al or ZVI. When using the electrode for water electrolysis purposes, the electrode active material may include Pt, IrO₂, RuO₂, or a combination thereof. In addition, when using the electrode in an electrochemical sensor, the electrode active material may include BDD. The electrode is usable for the purpose of evaluating the electrochemical properties of powder particles, in which case, the electrode active material may include Al. As described above, there may be an advantage in that the electrode is usable for various purposes through the appropriate selection of the electrode active material.

According to an embodiment, the electrode active material may be filled in an amount accounting for 90 vol % to 100 vol % of the cavities. As described above, the plurality of cavities included in the first frame and/or the second frame is filled with the electrode active material, and the electrode may include different amounts of the electrode active material depending on the purpose or the electrochemical reactivity of the electrode to be achieved. When the electrode active material is filled in an amount of less than 90 vol % of the cavities, the electrode active material, serving as the reaction site of the electrode, is sunken in the cavities and thus may inhibit contact between the electrode active material and the electrolyte, which may reduce the electrode reactivity. When the electrode active material is filled in an amount of more than 100 vol % of the cavities, the electrode active material is present to protrude from the cavities to the outside, in which case the protruded electrode active material has a weak binding strength to the frame and thus may be separated readily from the frame. As the protruded electrode active material outside the cavities is separated from the frame, the electrode active material present inside the cavities may be sequentially separated. This phenomenon, in turn, inhibits contact between the current collector and the electrode active material and thus may reduce the electrode reactivity. According to an embodiment, the electrode active material may be specifically filled in an amount of 95 vol % to 100 vol %, more specifically 99 vol % to 100 vol %, of the cavities.

According to an embodiment, the electrode may further include a conductive powder, wherein an inner space of the cavities may be filled with the conductive powder at a position deeper than that of the electrode active material. Among the electrode active material with which the cavities are filled, what acts as the reaction site is only the electrode active material exposed outside the cavities, and a portion thereof unexposed to the outside performs a role of electrically connecting the current collector and the electrode active material exposed to the outside. When the conductive powder with relatively inexpensive costs compared to the electrode active material is used as a material to provide such an electrical connection, there is an advantage in that the manufacturing cost of the electrode may be reduced. The conductive powder is not limited as long as it is electrically conductive, but inexpensive materials are preferable from the perspective of reducing the manufacturing cost of the electrode. Examples of inexpensive materials may include carbon-based conductive powders, such as graphite, carbon nanotubes (CNTs), and carbon black.

According to another embodiment of the present disclosure, a device including the above-described electrode is provided, wherein the device is used for at least one of water treatment, water electrolysis, and sensing. Among the components of the electrode, the first and second frames, the packing member, and the current collector may be simply washed for reuse, and the electrode active material alone may be appropriately selected depending on the purpose, so that the electrode configuration is easily changeable depending on the purpose. For example, when using the device for water treatment purposes, an electrode including the first and second frames, the packing member, the current-collecting member, and Al as the electrode active material may be arranged as an anode, and Pt may be arranged as a cathode, followed by immersing the anode and the cathode being connected to a power source in wastewater with which a reactor is filled. Then, current may be supplied to the electrodes to complete a water treatment reaction. Next, when using the device for water electrolysis purposes, the anode, the cathode, and the reactor may be simply washed without changing the configuration, and the electrode active material of the anode alone may be changed to RuO₂, thus simply changing the purpose of the device. In addition to the purposes mentioned above, this device may also be used for the purpose of evaluating the electrochemical properties of powdered particles.

Hereinafter, embodiments of the present disclosure will be further described with reference to specific experimental examples. However, the examples and comparative examples contained in the experimental examples are only provided to illustrate the embodiments of the present disclosure and not to limit the appended claims. It is apparent to those skilled in the art that various changes and modifications are possible within the scope and technical spirit of the present disclosure, and such changes and modifications fall within the appended claims. Furthermore, the embodiments may be combined to form additional embodiments.

### Example

### Preparation Example—Manufacture of Electrode Active Material Powder-Filled Electrode

First and second frames made of PC with dimensions of a width, a length, and a thickness of 30 mm×30 mm×3 mm, respectively, were prepared. The second frame among the two was prepared such that cavities having a diameter of 5 μm were formed in the second frame in three rows while the number of cavities in each row was 3, 3, and 2. A packing member made of silicone was attached to the surface of the second frame with which the first frame was overlaid. The first frame and the packing member attached to the second frame were compressed to form an inner space that was sealed except for one direction between the two frames by two frames and the packing member. That is, the first frame, the second frame, and the packing member defined the inner space that was open in one direction. In the inner space, a Pt current-collecting member was inserted, and the cavities of the second frame were filled with BDD powder and then compressed. The BDD was filled in an amount of 100 vol % of the cavities of the second frame. A working electrode was manufactured by performing the process described above.

### Comparative Preparation Example—Manufacture of Electrode Active Material Powder-Free Electrode

A working electrode was manufactured through the same process as in the preparation example, except that the cavities of the second frame were free of the electrode active material powder.

### Experimental Example 1-Comparison of Cyclic Voltammetry Curves for Electrodes

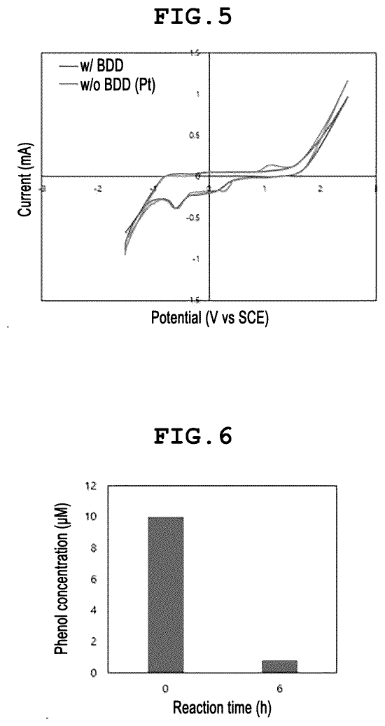

Each electrode of the preparation example and the comparative preparation example served as a working electrode, and a Pt foil was arranged as a counter electrode. Then, the working and counter electrodes were immersed in a 0.1 M NaClO₄ solution with voltage application. The saturated calomel electrode (SCE) was used as a reference electrode. The applied voltage was in the range of −1.5 V to 2.5 V, the scan rate was 50 mV/s, and the Estep was mV. The cyclic voltammetry results of the two working electrodes under the above driving conditions are as shown in FIG. 5.

From FIG. 5, the electrode of the preparation example, including the BDD powder as the electrode active material, was confirmed to show a similar cyclic voltammetry curve to that of the electrode of the comparative preparation example, free of the electrode active material. What is inferred therefrom may be that the electrode active powder with which the cavities of the second frame are filled contributes to the electrochemical activity of the electrode. In addition, when using the BDD powder-filled electrode of the preparation example for water treatment, the minimum voltage (overpotential) required for an OER, a side reaction, is low, thus enabling the inhibition of the OER and leading to an expectation that the electrochemical activity for water treatment is excellent.

### Experimental Example 2-Evaluation of Powder-Filled Electrode Reactivity in Phenol Oxidation Reaction

The electrode of the preparation example served as a working electrode, and a Pt foil served as a counter electrode. The working and counter electrodes were connected to a power source and then immersed in a 10 μM phenol aqueous solution, followed by supplying a current of 40 mA. Then, the initial phenol concentration and the phenol concentration 6 hours after the current supply were compared. The comparison results of the phenol concentrations are as shown in FIG. 6.

Referring to FIG. 6, the phenol concentration, initially 10 μM, was confirmed to decrease by about 92% to about 0.8 μM 6 hours after the current supply. What is inferred therefrom may be that the electrode of the preparation example, in which the cavities are filled with the BDD powder, is usable in electrochemical oxidation reactions of organic matter in wastewater.

### Experimental Example 3-Electrochemical Coagulation Reaction Test Using Powder-Filled Electrode

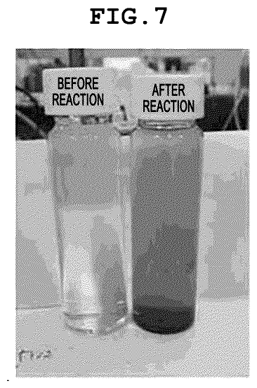

The electrode active material with which the cavities of the electrode of the preparation example were filled was replaced with ZVI. The filling rate of the cavities with the ZVI powder was 100 vol %. The electrode of the preparation example served as a working electrode, and a Pt foil served as the counter electrode. The working and counter electrodes were connected to a power source and then immersed in effluent prepared in advance with current supply. A current of 15 mA was supplied for 10 minutes, followed by comparing the appearance of the effluent after the current supply to that before the current supply. The comparison results are as shown in FIG. 7.

Referring to FIG. 7, when supplying the current to the electrode, iron hydroxide sludge was generated as iron ions from the ZVI powder, with which the working electrode was filled, were dissolved, confirming that the effluent became turbid after the current supply. Since iron hydroxide can act as a coagulant for organic contaminants in electrochemical water treatment, the ZVI-filled electrode was confirmed to be usable in electrochemical coagulation reactions.

The above description of an embodiment is merely an example to which the principles of the present disclosure are applied, and other embodiments may be further included without departing from the scope of the present disclosure.

What is claimed is:

1. An electrode comprising:
a first frame and a second frame, wherein the first and second frames are non-conductors, and at least one of the first and second frames comprises a plurality of cavities;
a packing member disposed between the first and second frames and attached to one of the first and second frames, wherein the first frame, the second frame, and the packing member define an inner space that is open in one direction;
a current-collecting member interposed in the inner space; and
a powdered electrode active material with which the plurality of cavities is filled, the electrode active material contacting the current-collecting member.

2. The electrode of claim 1, wherein the first and second frames comprise polycarbonate (PC), polytetrafluoroethylene (PTFE), or polyether ether ketone (PEEK).

3. The electrode of claim 1, wherein each of the plurality of cavities has a diameter in a range of 2 mm to 20 mm.

4. The electrode of claim 1, wherein the plurality of cavities has a total cross-sectional area accounting for 3% to 60% of the total area of the electrode.

5. The electrode of claim 1, wherein each of the first and second frames has a thickness in a range of 1 mm to 3 mm.

6. The electrode of claim 1, wherein the packing member comprises silicone, a synthetic rubber, a synthetic resin, or a combination thereof.

7. The electrode of claim 1, wherein the current-collecting member comprises Pt, Au, Cu, Ni, Ti, or a combination thereof.

8. The electrode of claim 1, wherein the current-collecting member comprises:
a conductive substrate; and
a current collector layer with which an upper portion of the conductive substrate is coated, wherein the current collector layer is wire-type.

9. The electrode of claim 1, wherein the electrode active material comprises boron-doped diamond (BDD), magneli, zerovalent iron (ZVI), aluminum (Al), Pt, IrO₂, RuO₂, or a combination thereof.

10. The electrode of claim 1, further comprising:
a conductive powder, wherein an inner space of the cavities is filled with the conductive powder at a position deeper than that of the electrode active material.

11. The electrode of claim 1, wherein the electrode active material is filled in an amount accounting for 90 vol % to 100 vol % of the cavities.

12. A device comprising:
the electrode of claim 1, wherein the device is used for at least one of water treatment, water electrolysis, and sensing.

13. An electrode comprising:
first and second non-conductor frames comprising a plurality of cavities filled at least partially with an electrode active material;
a packing member disposed between the first and second frames; and
a current-collecting member disposed in an inner space defined by the first frame, the second frame, and the packing member;
wherein the electrode active material contacts the current-collecting member.

14. The electrode of claim 13, wherein the first and second frames comprise polycarbonate (PC), polytetrafluoroethylene (PTFE), or polyether ether ketone (PEEK).

15. The electrode of claim 13, wherein each of the plurality of cavities has a diameter in a range of 2 mm to 20 mm.

16. The electrode of claim 13,
wherein each of the plurality of cavities has a diameter in a range of 2 mm to 20 mm,
wherein the plurality of cavities has a total cross-sectional area accounting for 3% to 60% of the total area of the electrode, and
wherein each of the first and second frames has a thickness in a range of 1 mm to 3 mm.

17. The electrode of claim 13, wherein the packing member comprises silicone, a synthetic rubber, a synthetic resin, or a combination thereof.

18. The electrode of claim 13, wherein the current-collecting member comprises Pt, Au, Cu, Ni, Ti, or a combination thereof.

19. The electrode of claim 13, wherein the current-collecting member comprises:
a conductive substrate; and
a current collector layer with which an upper portion of the conductive substrate is coated, wherein the current collector layer is wire-type.

20. The electrode of claim 13, wherein the electrode active material comprises boron-doped diamond (BDD), magneli, zerovalent iron (ZVI), aluminum (Al), Pt, IrO₂, RuO₂, or a combination thereof,
wherein an inner space of the cavities is filled with the conductive powder at a position deeper than that of the electrode active material, and
wherein the electrode active material is filled in an amount accounting for about 90 percent of the cavities.
